(19) United States
(12) Patent Application Publication
(10) Pub. No.: US 2017/0185730 A1
(43) Pub. Date: Jun. 29, 2017

(54) MACHINE LEARNING APPROACH TO SELECTING CANDIDATES

(71) Applicant: Case Western Reserve University, Cleveland, OH (US)

(72) Inventors: Cameron C. McIntyre, Cleveland Heights, OH (US); Reuben R. Shamir, Cleveland, OH (US); Benjamin L. Walter, Cleveland, OH (US); Trygve Dolber, Atlanta, GA (US)

(21) Appl. No.: 15/393,352

(22) Filed: Dec. 29, 2016

Related U.S. Application Data
(60) Provisional application No. 62/272,260, filed on Dec. 29, 2015.

(51) Int. Cl. G06F 19/00; G06N 99/00

(52) U.S. Cl. CPC G06F 19/345; G06N 99/005

(57) ABSTRACT

Example apparatus and methods concern a clinical decision support system for the selection of candidates. A clinical decision support system includes a candidate data logic that receives electronic data that identifies candidate data, including symptom and non-symptom data, for a candidate. The clinical decision support system also includes a scoring logic that generates a score for the candidate based, at least in part, on a set of rules being applied to the candidate data. The set of rules is based on patient data of a set of patients. The clinical decision support system further includes an identification logic that identifies a personalized treatment for the candidate based, at least in part, on the score.

### CROSS-REFERENCE TO RELATED APPLICATIONS

This Application claims the benefit of U.S. Provisional Patent Application No. 62/272,260 filed Dec. 29, 2015.

### FEDERAL FUNDING NOTICE

The invention was made with government support under Federal Grant No. NS047388 awarded by the National Institute of Health. The government has certain rights in the invention.

### BACKGROUND

Selecting candidates for a treatment of a disease can be difficult because the efficacy of outcomes varies based on individual patients' experience with the disease. This issue is further complicated as some treatments that can be effective are also invasive or may be otherwise detrimental to a patient, necessitating balancing the possibility of positive outcomes with negative side effects.

For example, deep brain stimulation (DBS) of the subthalamic region is an effective treatment for the motor symptoms of advanced Parkinson's disease. However, DBS involves implanting a nerostimulator into a patient's brain. This is an invasive procedure that might not be effective for every patient. Furthermore, following surgery to implant the DBS system in the Parkinson's disease patient, a clinician may be confronted with the challenge of balancing the patient's drug treatment and stimulation treatment to maximize therapeutic benefit while minimizing adverse effects. Conventionally, this complex process is driven by clinical experience, and despite clinicians best effort may have some adverse effects and/or unsatisfactory outcomes in some patients. Accordingly, patient's may undergo a treatment, such as DBS, that ultimately does not prove effective for them and also complicates less invasive treatments, such as drug treatment.

### BRIEF DESCRIPTION OF THE DRAWINGS

The accompanying drawings, which are incorporated in and constitute a part of the specification, illustrate various example devices, methods, apparatus and other embodiments of various aspects of the invention. It will be appreciated that the illustrated element boundaries (e.g., boxes, groups of boxes, or other shapes) in the figures represent one example of the boundaries. In some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates an example clinical decision support system.

FIG. 2 illustrates an example of patient scores for a set patients before and after a treatment.

FIG. 3A illustrates an example decision tree that classifies candidates based on patient data of a set patients.

FIG. 3B illustrates an example decision tree associated with DBS that classifies candidates based on the patient data of a set patients.

FIG. 4 illustrates an example clinical decision support system having a learning logic.

FIG. 5 illustrates pre-operative improvement relative to post-operative improvement in a set of patients.

FIG. 6 illustrates an example method associated with a clinical decision support system.

FIG. 7 illustrates an example method associated with a clinical decision support system comparing a score to a threshold.

FIG. 8 illustrates an example apparatus associated with a clinical decision support system.

FIG. 9 illustrates an example apparatus associated with a clinical decision support system having a learning logic.

### DETAILED DESCRIPTION

Some patients may suffer negative consequences from treatments. For example, deep brain stimulation (DBS) is neurosurgical procedure involving implantation of a medical device called a neurostimulator, which sends electrical impulses to specific targets in the brain. DBS of the subthalamic nucleus (STN) is generally effective for the treatment of movement and neuropsychiatric disorders such as Parkinson's disease, essential tremor, dystonia, chronic pain, major depression, and obsessive-compulsive disorder (OCD), etc. However, some patients suffer negative consequences from DBS, such as adverse effects and/or unsatisfactory outcomes. Even if the patient does not suffer negative consequences, subjecting a patient to an implantation operation for moderate if any benefit, may be undesirable. Accordingly, clinicians attempt to select candidates that would garner greater benefit from treatments, such as DBS.

Traditionally, clinicians select candidates based on the likelihood that the patient's symptoms would improve. For example, clinicians may select DBS patients that have demonstrated at least a 30% improvement of one of their symptoms, due to medication alone, before the implantation operation. However, recent studies have suggested that this measure is not well correlated with post-operative DBS outcomes. Furthermore, patients that have shown great improvement on medication, may have maximized their potential motor symptom improvement, and thus, would not benefit from DBS. The 30% improvement threshold also suffers from being an assessment of the patient at single point in time, which may not be indicative of the patient's overall improvement or account for longitudinal changes.

Described herein are example apparatus and methods for a machine learning approach to selecting candidates for whom the treatment would be effective. Continuing the example of DBS, the example apparatus and methods for a machine learning approach may select candidates for STN therapy in order to avoid consequences for those candidates for whom STN is not effective. For ease of understanding and consistency, examples are provided concerning the treatment of Parkinson's disease patients and treatments (e.g., STN therapy) related to Parkinson's disease. While the examples concern Parkinson's disease patients, example apparatus and methods are more generally applicable to candidates being selected for treatments of other illnesses, injuries, clinical trials, medical applications, etc.

In one embodiment, a clinical decision support system is provided that facilitates selecting candidates for a treatment based on the performance of patients that have undergone the treatment. In particular, candidate specific data is considered with respect to patient data for a set of patients. For example, a symptom of a candidate may be assessed a scored based on a set of rules derived from a set of patient data. Because the score is based on patient data of a set of patients that have undergone treatment, a personalized treatment plan can be developed for the candidate. For example, a personalized treatment for Parkinson's disease may include combinations of stimulation and medication.

The set of rules may be derived from the set of patient data related to the patient data of a set of patients based on similarity functions trained up by machine learning algorithms. For example, machine learning algorithms may incorporate patient-specific details of the set of patients to identify clinically relevant treatments, such as balances between stimulation parameters and medication parameters. One example clinical decision support system uses a multi-linear regression analysis that fits patient data with the actual outcome data using a linear weighted sum function. In one embodiment, the example linear weighted sum function may be produced and then manipulated (e.g., updated) using machine learning techniques that facilitate optimizing predictions for outcomes. While a weighted sum function is described, more generally machine learning techniques facilitate manipulating functions used by the clinical decision support system to predict outcomes for various combinations of stimulation and medication.

Using rule based selection incorporating patient specific data can improve candidate selection. Candidate selection can be further improved with the assistance of machine learning methods. For example, the current preoperative screening for DBS therapy can be improved by adding a set of rules or with the assistance of machine learning methods. It enables better selection of patients who would benefit from DBS, as well as identification of good candidates that otherwise would be screened out by the current selection processes. Furthermore, the use of machine learning methods in DBS patient selection may help avoid surgery on patients that are not likely to respond. Such methods could also assist in setting realistic patient expectations which may in turn yield higher satisfaction with the intervention.

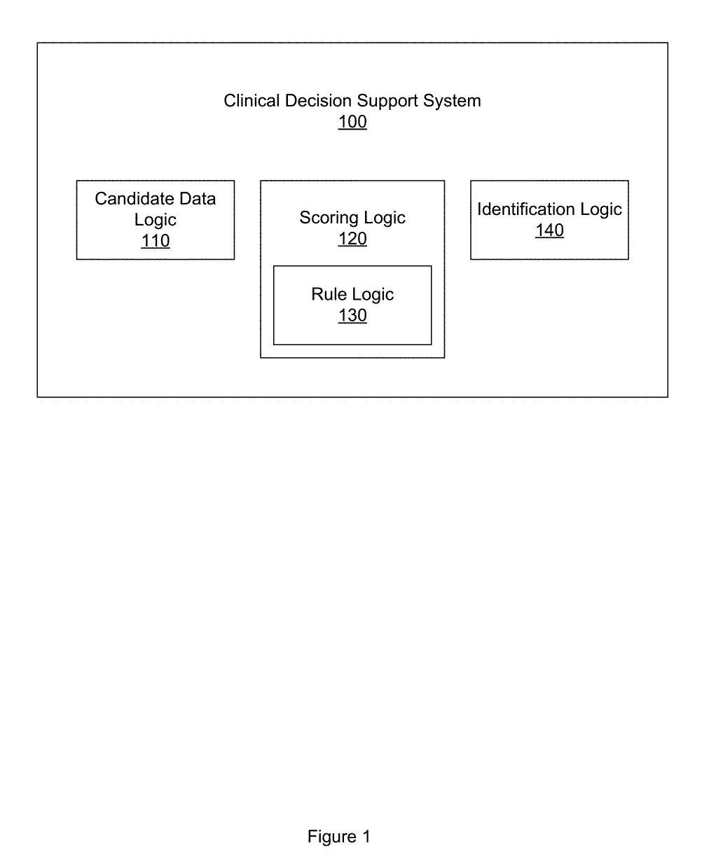

FIG. 1 illustrates an example clinical decision support system 100. The clinical decision support system 100 may be used in conjunction with systems for developing clinical trials, hospital protocols, and medical selection processes. Accordingly, the clinical decision support system 100 may incorporated with other medical systems. The clinical decision support system 100 includes a candidate data logic 110, a scoring logic 120, and an identification logic 140. The scoring logic 120 includes a rule logic 130.

The candidate data logic 110 receives electronic data that identifies candidate data for a candidate for a treatment. The candidate data received by the candidate data logic 110 may be received from the candidate or a medical database with access to the candidate data. In some embodiments, the candidate data logic 110 may request and receive specific candidate data or a set of candidate data from various resources such as medical institutions.

For example, the candidate data logic 110 may receive candidate data based on candidate symptom data and candidate non-symptom data (e.g., demographic data). In particular, the candidate data logic 110 may look at one or more of age, date of diagnosis, candidate-specific symptoms, clinical history, previous or current medication dosages (e.g., levodopa equivalent daily dosage (LEDD)), and parameters of other treatments. For example, for a candidate undergoing STN, the candidate data may include an estimated stimulation volume (ESV) of tissue stimulated by the DBS system and a therapeutic target volume. The candidate-specific symptoms may include data regarding tremor, rigidity, bradykinesia, and other symptoms.

In one embodiment, the patient outcomes are included in the patient data. Consider that the patients of the set of patients have Parkinson's disease. The patient data includes electronic data associated with the unified Parkinson's disease rating scale, part III (UPDRS-III) which is used to track the longitudinal course of Parkinson's disease including patient demographics, symptoms, patient outcomes, etc. The UPDRS-III preoperative scores are presented as mean±standard deviation (total possible score). In this example, the UPDRS-III was used to assess patients preoperatively both off (>12 hours) and on dopaminergic medication. For example, postoperatively, UPDRS-III was used to assess at a total of 335 follow-up visits of the 49 patients, each visit either on-medication/on-stimulation or off-medication/on-stimulation of STN. Patient data for patients who were assessed approximately one year after surgery in an on-medication and on-stimulation state under a stable medication dosing and stimulation setting regimen, is shown in Table 1 below. Accordingly, the patient data can be arranged by motor symptoms and magnitude.

TABLE 1

| Age at surgery | 62.2 ± 8.0 | years |
|---|---|---|
| Age at diagnosis | 48.4 ± 10.0 | years |
| Disease duration | 13.8 ± 9.3 | years |
| Sex | M = 20/F = 8 | |
| Preoperative | 1381 ± 506 | mg |
| LEDD | | |
| UPDRS-III | | |
| Speech | 36.8 ± 9.2 | (108) |
| Tremor | 0.9 ± 0.5 | (4) |
| Rigidity | 5.6 ± 3.9 | (28) |
| Limb | 5.7 ± 2.2 | (20) |
| Bradykinesia | 13.2 ± 4.3 | (32) |
| Axial | 8.6 ± 3.6 | (24) |
| Bradykinesia | | |

The scoring logic 120 generates a score for the candidate based, at least in part, on a set of rules being applied to the candidate data. The set of rules is based on the patient data of a set of patients. The outcomes of the set of patients is determined using patient data from the set of patients. The patient data may be received by the scoring logic 120 as electronic data from, for example, large-scale clinical trial results, patient diaries, medical record aggregators, and studies of patients using wearable sensors with continuous monitoring. In this manner, patient data can be collected from a large group of patients.

The rule logic 130 manages the set of rules. The set of rules is based on classification of the patient data, and more particularly the outcomes, experienced by the set of patients. In particular, the classification is based on the patient data. The scoring logic 120 generates a score for the candidate based, at least in part, on a set of rules being applied to the candidate data. For example, the scoring logic 120 may generate a score based on the similarity of the candidate data to the patient data.

The identification logic 140 identifies a personalized treatment for the candidate based, at least in part, on the score. The personalized treatment may be based on the score being indicative of a candidate having a similar outcome as similarly situated patients. In one embodiment, the identification logic 140 facilitates understanding a treatment being considered by visualizing past patient outcomes. Accordingly, the candidate may be selected for a personalized treatment based on the identification logic 140. The selection can be used to make recommendations to medical staff.

Accordingly, the rule logic 130 of the clinical decision support system 100 may use similarity functions that are trained up and optimized using machine learning methods derived from correlation and regression analyses. Because the rule logic 130 is provided with patient-specific details of the patient data, the rule logic 130 is able to adapt rules to candidate data and score the candidate accordingly. The identification logic 140 can then identify a personalized treatment for the candidate based on the experience of similarly situated patients. Therefore, the complex relationships between many influential variables represented by the patient data may be considered to more accurately in order to predict outcomes.

A production clinical decision support system 100 may be updated with retrospective and/or prospective patient data to improve the performance of the clinical decision support system 100, as the more patient data available the better predictive value of the score. Furthermore, the clinical decision support system 100 may be used to make recommendations regarding candidate selection to medical staff.

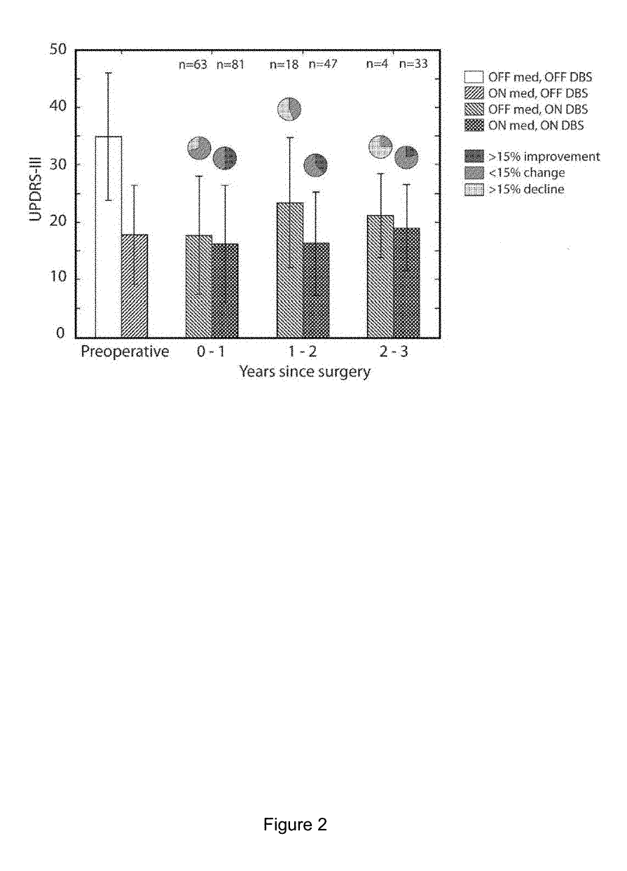

FIG. 2 shows the example average UPDRS-III scores pre- and post-operatively over three years for the example 49 patients. As shown, there is variability in the treatment outcomes. Therefore, the example patients can be classified into three groups 210, 220, and 230, based on a first group 210 illustrating greater than 15% symptom improvement in the UPDRS-III score with DBS alone or with DBS and medication at one year after surgery compared to medication alone before surgery, a second group 220 illustrating less than 15% change (improvement or worsening), and a third group illustrating greater than 15% worsening (presumably resulting from the progression of Parkinson's disease).

In particular, the classification is based on the relative improvement of the motor symptoms on-medication condition before surgery, to the on-stimulation and on/off-medication condition after surgery were defined to avoid a bias in the correlation coefficients:

$$\begin{matrix}\begin{matrix}\begin{matrix}100 \times \frac{{PRE}_{off} - {PRE}_{on}}{{PRE}_{off}} , & 100 \times \frac{{PRE}_{off} - {POST}_{stim}}{{PRE}_{off}} and \\ 100 \times \frac{{PRE}_{off} - {POST}_{both}}{{PRE}_{off}} & \end{matrix} & \end{matrix} & \end{matrix} \qquad ( Eq . 1 )$$

where PRE_{off}, PREₒₙ, POSTₛₜᵢₘ and POST_{both} represent the UPDRS-III score preoperative off-medication, preoperative on-medication, postoperative off-medication/on-stimulation, and postoperative on-medication/on-stimulation, respectively. These example results, from the set of patients do not support the conventional conclusion that the postoperative relative improvement in UPDRS-III on-medication and on-stimulation is correlated with the preoperative on-medication improvement. Instead, the patient data of patients can be classified into groups, such as groups, 210, 220, and 230, based on the symptomology and treatment outcomes experienced by the patients.

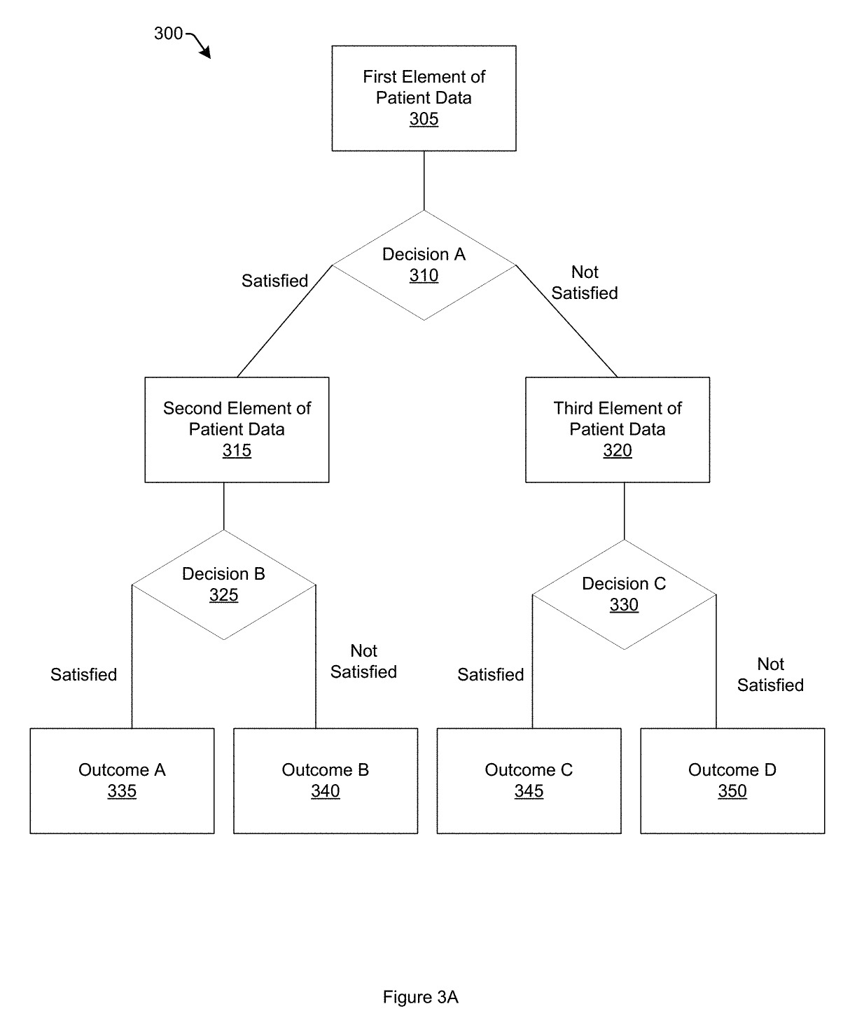

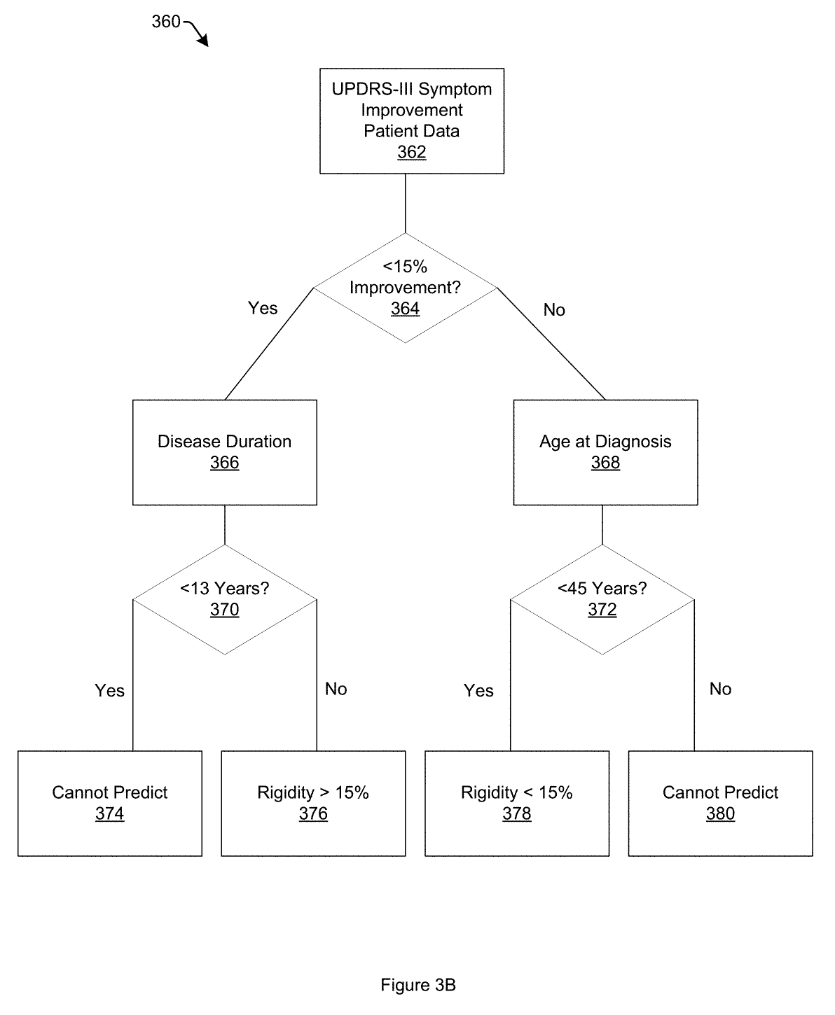

FIG. 3A illustrates an example decision tree 300 that classifies candidates based on the patient data of a set patients. The ability to classify the patient data into groups allows the machine learning algorithms to generate a set of rules. A rule is a decision leads to one of a plurality of nodes based on the patient data. For example, a first element of patient data 305 can be classified into two nodes of patient data, such as a second element of patient data 315 or a third element of patient data 320 based on a decision A 310 regarding the first element of patient data 305. Accordingly, this classification of an element of patient data into other elements of patient data based on a decision is a rule.

The set of rules also includes a rule based on the second element of the patient data 315 being classified into an Outcome A 335 and Outcome B 340 based on Decision B 325, and a rule based on the third element of the patient data 320 being classified into an Outcome C 345 and Outcome D 350 based on Decision C 330. In the embodiment illustrated in FIG. 3A, the rules are arranged into decision tree 300 that acts as a vehicle for applying the rules to candidate data.

FIG. 3B illustrates an example decision tree associated with DBS that classifies candidates with Parkinson's disease based on the patient data of a set patients. In particular, FIG. 3B illustrates a decision tree 360 based, at least in part, on the set of rules that distinguish the patient data. For example, the patient data may be distinguished based, at least in part, on distribution of motor symptoms and magnitude of symptoms. The decision tree 360 may terminate into a plurality of outcomes based, at least in part, experiences of the set of patients. The decision tree 360 is used to identify an outcome for the candidate data by applying the candidate data to the rules outlined in the decision tree 360. In other words, the candidate data described with respect to FIG. 1 may be applied to the decision tree.

Suppose that the candidate data includes UPDRS-III data for a candidate that shows that the candidate experienced a greater than 15% improvement in symptoms. The UPDRS-III data pertains to UPDRS-III Symptom Improvement Patient Data 362 derived from a group of patients. At Decision 364, it is determined whether the candidate experienced less than a 15% symptom improvement. If yes, the decision tree 360 would progress to Disease Duration 366. Instead, in the example given, the candidate experienced greater than a 15% improvement in symptoms. Accordingly, the decision tree 360 progresses to Age at Diagnosis 368. Therefore, the candidate data does not apply to Decision 370, at which it is determined whether the disease duration has been less than or greater than 13 years, leading to outcome 374 of cannot predict or Outcome 376 of a rigidity improvement of greater than 15%, respectively.

At age of Diagnosis 368 progresses to Decision 372 at which it is determined whether the candidate's age at diagnosis was less than 45 years old. If yes, the decision tree 360 progresses to Outcome 378 of a rigidity improvement of less than 15%. If no, the decision tree 360 progresses to Outcome 380 that is non-predictive. An outcome may be non-predictive if some of the classified groups of patients were associated with mixed outcomes. For these candidates, the outcomes were unpredictable according to the rules, indicating that additional rules, analysis, and/or patient data to make a determination. Based on these outcomes, a personalized treatment for the candidate can be identified.

FIG. 3B as it relates to identifying an outcome for a candidate with Parkinson's disease based on patient data for a group of patients having Parkinson's disease is given as an example embodiment. As discussed above, the embodiments discussed herein are more broadly applicable to other injuries, illnesses, and medical applications.

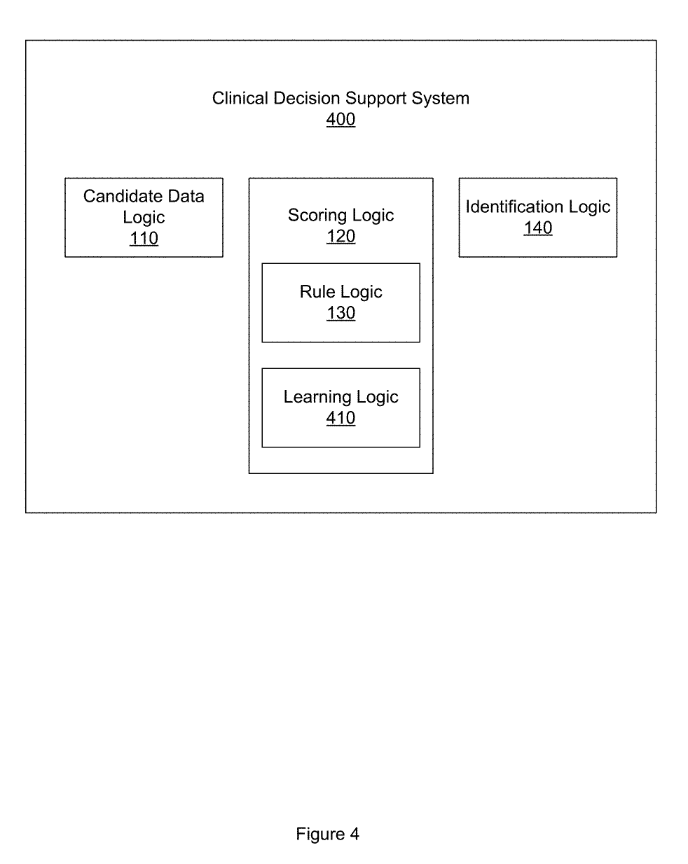

FIG. 4 illustrates an example clinical decision support system 400. The candidate data logic 110, the scoring logic 120, the rule logic 130, and the identification logic 140 operate in a similar manner as described above with respect to FIG. 1. In the embodiment shown in FIG. 4, the scoring logic 120 further includes a learning logic 410. The learning logic 410 uses machine learning techniques to update and manage the set of rules of the rule logic 130. The machine learning techniques may employ a number of analyses to update and manage the set of rules.

In one embodiment, the rule logic 130 may employ similarity functions trained up by learning logic 410 to classify the outcomes experienced by the patients based on the patient data. This allows the rule logic 130 groups patients with similar outcomes based on their similar symptoms.

In another embodiment, the learning logic 410 may employ a multi-linear regression analysis that fits patient data with the outcome data using a linear weighted sum function. The example linear weighted sum function may be produced and then manipulated (e.g., updated) using machine learning techniques of the learning logic 410 as new patient data is incorporated by the scoring logic 120.

Management of the rules may include arrangement of the rules into a decision tree, like decision tree 300 or 360. In one embodiment, the learning logic 410 may be configured to generate a random forest with an ensemble of a plurality of decision trees. In another embodiment, the learning logic 410 may include machine learning classifiers trained to automatically predict treatment outcomes: For example, the learning logic 410 may be configured to support vector machine with least squares function and quadratic kernel.

To employ these analyses the learning logic 410 uses the patient data. Consider the DBS examples discussed above, the following patient data may be considered for inclusion in predicting the postoperative outcomes: preoperative motor relative improvement as shown in Equation 1 above, temporal factors including age at surgery, age at diagnosis, and duration of disease, sex, and/or other symptom and non-symptom data. Additionally or alternatively, the learning logic 410 may also consider patient data regarding previous or parallel treatment data, such as preoperative Levodopa equivalent daily dosage. Levodopa equivalent daily dosage (LEDD) may be computed from each patient's medication record pre- and post-operatively. Furthermore, the relative change in LEDD may be defined as follows:

$$100 \times \frac{{LEDD}_{pre} - {LEDD}_{post}}{{LEDD}_{pre}} \qquad ( 2 )$$

Where LEDDₚᵣₑ represents the LEDD before surgery, and LEDDₚₒₛₜ represents the LEDD after surgery.

The learning logic 410 selects the most relevant features with the “best individual N method” using a Pearson correlation measure for ranking as shown below in Table 2. The accuracy may be measured using leave-one-out validation and counted the correct predictions using their implementation of decision binary trees, support vector machine, and random forest.

TABLE 2

| Predicted | | | | | | | |
|---|---|---|---|---|---|---|---|
| Outcome | Method | Selected features | | | | | |
| UPDRS-III | SVM | Sex | Total | Limb | | | |
| | RF | Sex | Total | Limb | LEDD | | |
| Tremor | SVM | Total | Limb | Axial | Rigidity | LEDD | |
| | RF | Total | Limb | Axial | Rigidity | LEDD | |
| Rigidity | SVM | Limb | Axial | Total | Duration | | |
| | RF | Limb | Axial | Total | Duration | Sex | |
| Limb | SVM | Limb | Total | LEDD | Tremor | Sex | DA |
| Bradykinesia | | SA | Axial | Rigidity | Speech | | |
| | RF | Limb | Total | LEDD | Tremor | | |
| Axial | SVM | Limb | Axial | Tremor | | | |
| Bradykinesia | RF | Limb | Axial | Tremor | Total | | |

Using rule logic 130 and the learning logic 410, the scoring logic 120 is able to generate scores that represent prediction results. For example, Table 3 shown below, summarizes the prediction results of an example set of rules and possible analyses of the learning logic 410. Consider the DBS example, the rules set classification accuracies may be as follows (number of correct predictions/test set size): 25/28 (89%) for tremor, 18/20 (90%) for rigidity, 25/28 (89%) for limbs bradykinesia, 21/22 (95%) for axial bradykinesia, and 25/28 (89%) for the overall motor improvement with DBS and medication at one year after surgery compared to medication alone before surgery. A binary decision tree indicated unpredictable outcomes in 8 and 6 out of the 28 patients for rigidity and axial bradykinesia, respectively. In this manner, the scoring logic 120 is able to predict outcomes for candidates. Using these apparatuses and methods, candidates have been shown to be selected with accuracies including 26/28 (93%) for tremor, 21/28 (75%) for rigidity, 24/28 (86%) for limb bradykinesia, 25/28 (89%) for axial bradykinesia, and 25/28 (89%) for the overall motor outcome with DBS and medication at one year after surgery compared to medication alone before surgery.

TABLE 3

| | Binary decision | | | | | |
|---|---|---|---|---|---|---|
| | tree | | SVM | | RF | |
| Improvement | <15% | >15% | <15% | >15% | <15% | >15% |
| Tremor | 18/20 | 7/8 | 16/20 | 7/8 | 20/20 | 6/8 |
| Rigidity | 11/11 | 7/9 | 13/15 | 8/13 | 9/15 | 7/13 |
| Limb | 21/21 | 4/7 | 19/21 | 5/7 | 16/21 | 4/7 |
| bradykinesia | | | | | | |
| Axial | 21/22 | 0/0 | 20/24 | 2/4 | 23/24 | 2/4 |
| bradykinesia | | | | | | |
| UPDRS-III | 16/18 | 9/10 | 15/18 | 7/10 | 17/18 | 8/10 |

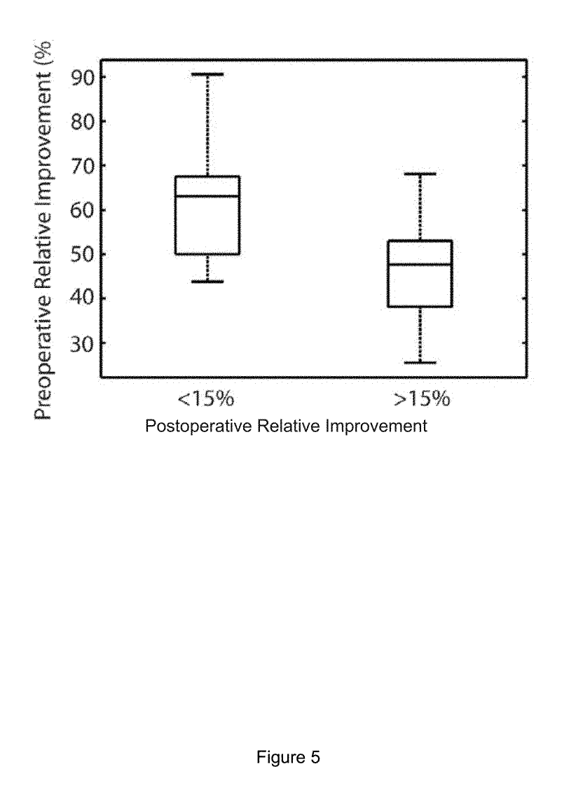

FIG. 5 illustrates pre-operative improvement relative to post-operative improvement in a set of patients. Preoperative relative improvement refers to the motor improvement as measured with UPDRS-III with medication in comparison to no medication before surgery. Postoperative relative improvement refers to the improvement with DBS and medication as measured with the UPDRS-III in comparison to no-medication before surgery. Accordingly, in one embodiment, a personalized treatment may be selected based on a threshold value. Thus, in the DBS example discussed herein, an example threshold value may be gaining an additional 15% improvement in a candidate's motor score with DBS and medication at one year after surgery in comparison to medication alone before surgery.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

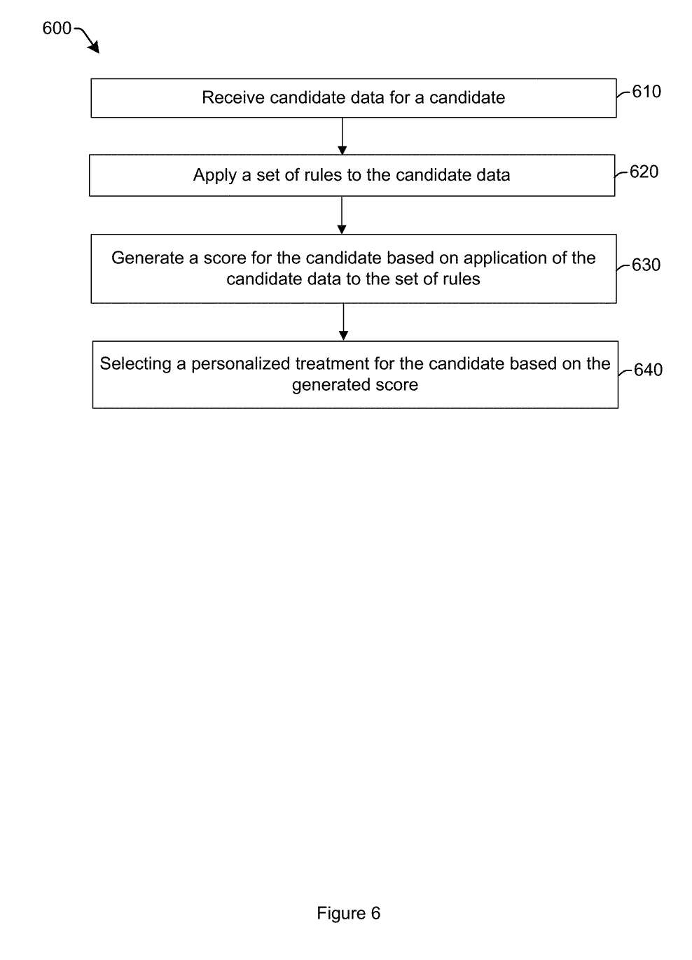

FIG. 6 illustrates an example method 600 for identifying a personalized treatment plan for a candidate. In one embodiment, the patient may be a Parkinson's disease patient. Method 600 includes, at 610, receiving candidate data for the candidate. In one embodiment, the candidate data includes both symptom data (e.g., UPDRS-III data) and non-symptom data (e.g., demographic data).

At 620, the method 600 includes applying a set of rules to the candidate data. The set of rules is based on the patient data. The rules may be used to identify similarities between a candidate and a set of patients that are similarly situated and have experienced similar symptoms and treatments. For example, a computer may be controlled to select candidate data corresponding to the patient data relevant to the set of rules.

At 630, a score is generated for the candidate based on application of the candidate data to the set of rules. For example, the computer may be controlled to compute a score for the candidate based on two or more elements of patient data. In one embodiment, a plurality of scores may be generated for a candidate based on the elements of patient data and attributes of a condition (e.g., Parkinson's disease). For example, suppose that a decision tree is formed from a plurality of rules. In one embodiment, a score may be generated for each rule and an aggregate score may be computed from the scores according to a linear weighted sum function. In one embodiment, method 600 may compute an aggregate score from the scores for two attributes, for four attributes, or for more attributes.

In one embodiment, the score is not a numerical value but a predictive outcome identified by the set of rules. For example, the score may be a predictive outcome pertaining to the symptom data of the candidate data, such as how a symptom may progress. Suppose that the predictive outcome is a prognosis related to the evolution of a particular symptom such as limb bradykinesia and whether limb bradykinesia will abate or worsen and to what extent.

At 640, a personalized treatment is identified for the candidate based on the generated score. For example, in an embodiment in which the score is indicative of a predictive outcome, the predictive outcome may represent treatments that have been beneficial for similarly situated patients. Alternatively, suppose that the score is a numerical value, the value may correspond to a particular treatment. In another embodiment, the value may be compared to a threshold. The threshold may be used to determine which if any treatment would be appropriate. In one embodiment, the threshold value predicts an amount of improvement of the at least one symptom in the candidate

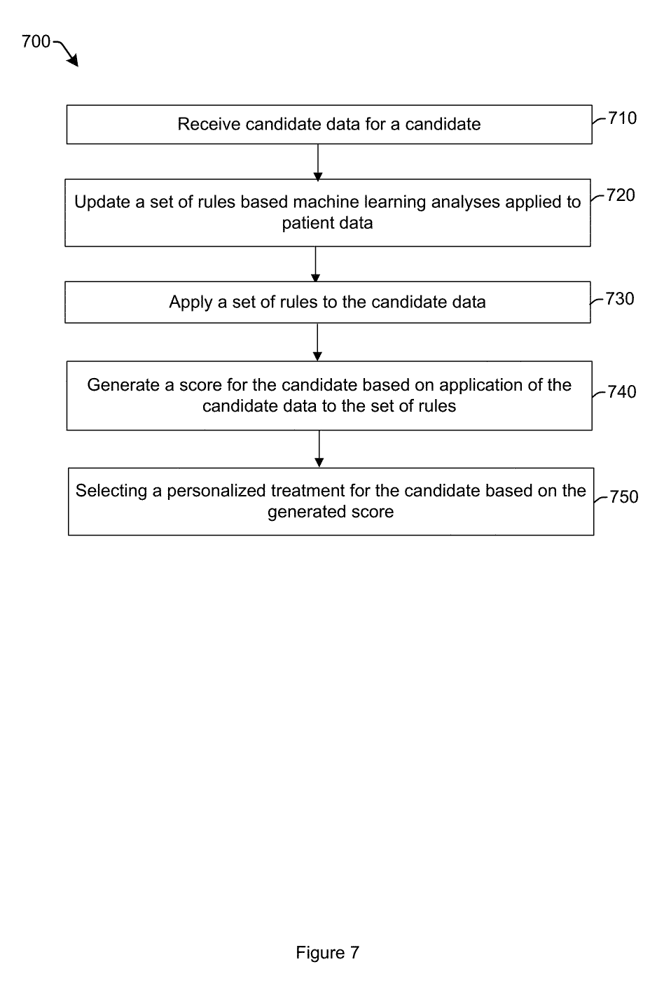

FIG. 7 illustrates another embodiment of method 600. Acts 610, 620, 630, and 640 correspond to acts 710, 730, 740, and 750, respectively. Method 700 further includes, at 720, updating the set of rules based on machine learning analyses applied to patient data. In one embodiment, the set of rules is updated based, at least in part, on newly received patient data. In another embodiment, the rules may be updated based on new research, such data from research, clinical trials, etc.

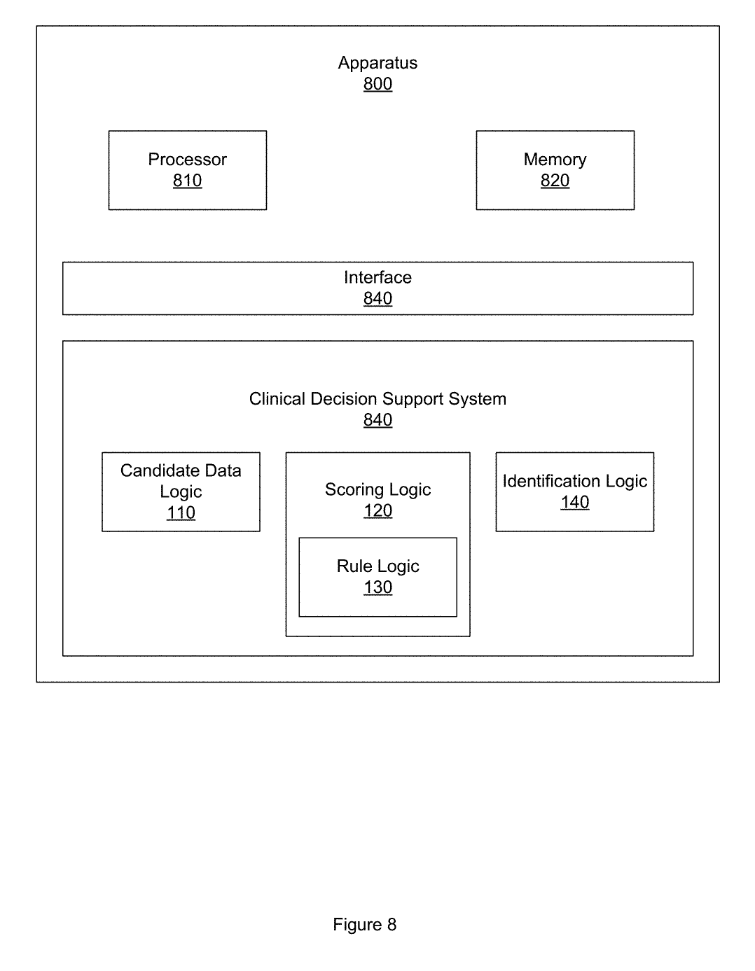

FIG. 8 illustrates an example apparatus 800 that identifying a personalized treatment plan for a candidate. Apparatus 800 includes a processor 810, a memory 820, a set of logics that form a clinical decision support system 830 that performs various actions for apparatus 800, and an interface 840. In one embodiment, the set of logics may be comprised of a collection of circuits. The clinical decision support system 830 includes candidate data logic 110, scoring logic 120, a rule logic 130, and an identification logic 140 that operate in a similar manner as described with respect to FIG. 1.

As discussed above the candidate data logic 110 and the scoring logic 120 operate based on candidate data and patient data. The candidate data and patient data may be electronic data may be stored in a memory 820. In one embodiment, the electronic data stored in the memory 820 may include medical records including medical imagery (e.g., MR image, CT image). The memory 820 may also store electronic data from large-scale clinical trial results, patient diaries, or studies of patients using wearable sensors with continuous monitoring.

The scoring logic generates a score based on the candidate data and patient data. The score characterizes the candidate based on the application of the candidate data to the rule logic 130, which are based on the patient data. For example, the candidate data may include data about the candidate corresponding to the patient data regarding, for example, data concerning tremor symptoms, rigidity symptoms, bradykinesia symptoms, speech symptoms, and axial akinetic symptoms. Other patient data may be analyzed for other conditions. The set of rules may also be based on non-symptom patient data including, for example, data concerning the age of the patient at the time the DBS electrode was implanted, data concerning an amount of time since the DBS electrode was implanted, data concerning a pre-operative motor improvement produced by levodopa, and data concerning a relative levodopa equivalent daily dosage (LEDD) reduction following implantation of the DBS electrode. Other non-symptom patient data may be analyzed for other conditions.

The processor 810 may be connected to the set of logics of the clinical decision support system 830 and the memory 820 by a hardware interface 840. Generating the score may employ the processor 810 compute a similarity metric for the candidate based, at least in part, on the candidate data and the patient data. In one embodiment, the processor 810 computes the similarity metric based on the patient symptom data, the non-symptom data, and the overlap between the ESV and the TSA. The processor 810 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware.

Once a value for the similarity metric has been determined, a third logic 833 may identify relevant data associated with a set of other patients and their therapeutic outcomes based on the similarity metric. In one embodiment, the third logic 833 identifies the relevant data based on a linear weighted sum function applied to data associated with the set of other patients. In one embodiment, the linear weighted sum function is the product of machine learning associated with multi-linear regression analyses that identify correlations in data associated with the set of other patients and their therapeutic outcomes. The machine learning may have included, for example, NB learning, RF of trees learning, and SVM learning. In one embodiment, the linear weighted sum function produces an aggregate score from separate scores for different members of the patient symptom data and the patient non-symptom data. The separate scores for different members of the patient symptom data and the patient non-symptom data may be selected from results produced by different machine learning. Alternatively, the processor 810 may be used to navigate a decision tree.

Apparatus 800 also includes an identification logic 140 that produces electronic data that identifies a combination of treatment parameters for the candidate based on the generated score.

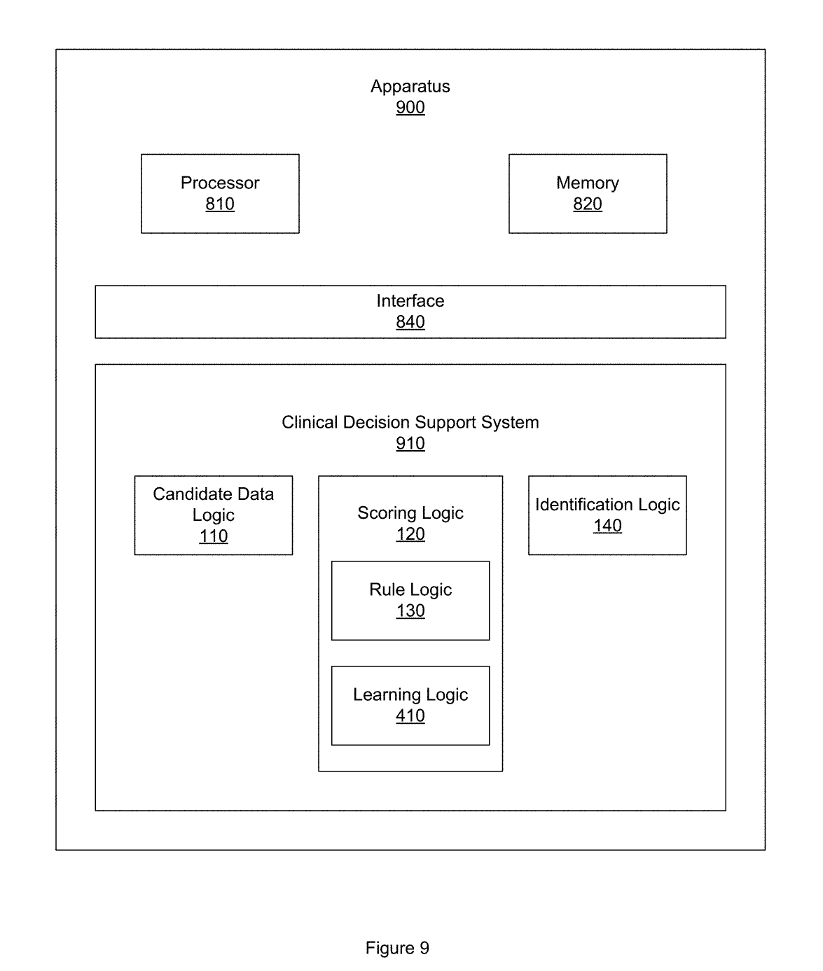

FIG. 9 illustrates another embodiment of apparatus 900. This embodiment includes a learning logic 410 that operated in a similar manner as the learning logic 410 described with respect to FIG. 4. In one embodiment, the functionality associated the clinical decision support system 910 may be performed, at least in part, by hardware logic components including, but not limited to, FPGAs, ASICs, application specific standard products (ASSPs), SOCs, or complex programmable logic devices (CPLDs).

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. “Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

“Circuit”, as used herein, includes but is not limited to hardware, firmware, software in execution on a machine, or combinations of each to perform a function(s) or an action(s), or to cause a function or action from another circuit, method, or system. Circuit may include a software controlled microprocessor, a discrete logic (e.g., ASIC), an analog circuit, a digital circuit, a programmed logic device, a memory device containing instructions, and other physical devices. Circuit may include one or more gates, combinations of gates, or other circuit components. Where multiple logical circuits are described, it may be possible to incorporate the multiple logical circuits into one physical circuit. Similarly, where a single logical circuit is described, it may be possible to distribute that single logical circuit between multiple physical circuits.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

What is claimed is:

1. A clinical decision support system for candidate selection, comprising:
a candidate data logic that receives electronic data that identifies candidate data for a candidate;
a scoring logic that generates a score for the candidate based, at least in part, on a set of rules being applied to the candidate data, wherein the set of rules is based, at least in part, on patient data of a set patients; and
an identification logic identifies a personalized treatment for the candidate based, at least in part, on the score.

2. The clinical decision support system for candidate selection of claim 1, wherein the scoring logic includes a learning logic that updates the set of rules based, at least in part, on machine learning analyses.

3. The clinical decision support system for candidate selection of claim 1, wherein the patient data is classified based, at least in part, on the set of rules and arranged into a decision tree.

4. The clinical decision support system for candidate selection of claim 3, wherein nodes of the decision tree correspond to elements of patient data.

5. The clinical decision support system for candidate selection of claim 3, wherein the set of rules distinguish patient data based, at least in part, on distribution of motor symptoms and magnitude of symptoms.

6. The clinical decision support system for candidate selection of claim 1, wherein the patient data is received as electronic data from large-scale clinical trial results, patient diaries, and studies of patients using wearable sensors with continuous monitoring.

7. The clinical decision support system for candidate selection of claim 1, wherein the personalized treatment includes deep brain stimulation.

8. The clinical decision support system for candidate selection of claim 1, wherein the candidate data is associated with Parkinson's disease.

9. The clinical decision support system for candidate selection of claim 1, wherein the candidate data is a tremor symptom, rigidity symptom, bradykinesia symptom, speech symptom, or axial akinetic symptom.

10. A method for candidate selection, comprising:
receiving electronic data that identifies candidate data for a candidate;
applying a set of rules to the candidate data, wherein the set of rules is based, at least in part, on classification of patient data of a set patients;
generating a score for the candidate based on application of the candidate data to the set of rules, wherein the score defines a predictive outcome of a personalized treatment for the candidate; and
selecting the personalized treatment for the candidate based, at least in part, on the score.

11. The method of candidate selection of claim 10, wherein the score corresponds to efficacy of outcomes.

12. The method of candidate selection of claim 10, wherein the patient data is classified based, at least in part, on the set of rules that arrange the patient data into a decision tree.

13. The method of candidate selection of claim 12, wherein the set of rules distinguish the patient data based, at least in part, on distribution of motor symptoms and magnitude of symptoms.

14. The method of candidate selection of claim 10, wherein the patient data is received as electronic data from large-scale clinical trial results, patient diaries, or studies of patients using wearable sensors with continuous monitoring.

15. The method of candidate selection of claim 10, wherein the candidate data includes symptom.

16. A non-transitory computer-readable storage device storing computer-executable instructions that when executed by a computer cause the computer to perform a method for candidate selection, the method comprising:
receiving electronic candidate data associated with a candidate;
applying a set of rules to the candidate data, wherein the set of rules is based, at least in part, on a classification of patient data of a set of patients; and
generating a score for the candidate, wherein the score defines a predictive outcome of a personalized treatment for the candidate.

17. The non-transitory computer-readable storage device of claim 16, further comprising:
comparing the score to a threshold value, wherein the threshold value predicts an amount of improvement of at least one symptom in the candidate.

18. The non-transitory computer-readable storage device of claim 16, wherein the patient data represents efficacy of outcomes of the set of patients.

19. The non-transitory computer-readable storage device of claim 18, wherein the outcomes are classified based, at least in part, on rules of the set of rules that arrange the outcomes into a decision tree.

20. The non-transitory computer-readable storage device of claim 18, wherein the set of rules distinguish the outcomes based, at least in part, on distribution of motor symptoms and magnitude of symptoms.
